(19) United States
(12) Patent Application Publication
(10) Pub. No.: US 2026/0296188 A1
(43) Pub. Date: Oct. 1, 2026

(54) HEAD-UP DISPLAY

(71) Applicant: Panasonic Automotive Systems Co., Ltd., Kanagawa (JP)

(72) Inventors: Tomoaki MIYAMOTO, Osaka (JP); Ryotaro KOGA, Kanagawa (JP)

(73) Assignee: Panasonic Automotive Systems Co., Ltd., Kanagawa (JP)

(21) Appl. No.: 19/453,091

(22) Filed: Jan. 20, 2026

(30) Foreign Application Priority Data
Mar. 31, 2025 (JP) 2025-058078

(51) Int. Cl. B60K 35/231; G02B 27/01

(52) U.S. Cl. CPC B60K 35/231; G02B 27/0101; B60K 2360/31; B60K 2360/691; B60Y 2304/01; B60Y 2410/122; G02B 2027/013; G02B 27/0149; G02B 2027/015

(57) ABSTRACT

A head-up display forms a virtual image by projecting display light onto a display medium and includes: an enclosure to which a reflective mirror and a display element are attached. The display element displays an image to emit the display light forming a projected image on the display medium, the reflective mirror reflects the display light toward the display medium, the enclosure is formed as a resin injection-molded component, and when a direction along a parting line plane formed by a cavity and a core of a mold for forming the enclosure is defined as an X-axis direction and a direction along a display surface of the display element that corresponds to a left-right direction of the virtual image is defined as the X-axis direction, the display element is attached to the enclosure with the parting line plane being substantially parallel to the X-axis direction.

### CROSS REFERENCE TO RELATED APPLICATION

The present application is based on and claims priority of Japanese Patent Application No. 2025-058078 filed on Mar. 31, 2025.

Field

The present disclosure relates to a head-up display.

### BACKGROUND

Patent Literature (PTL) 1 discloses a plane mirror unit provided in a vehicle and capable of projecting an image. This plane mirror unit is provided in a head-up display device that displays an image as a virtual image by emitting display light indicating an image emitted by a display from an ejection port toward a light-transmissive member located outside a case.

Citation List

Patent Literature

PTL 1: Japanese Patent No. 6969424

### SUMMARY

However, the head-up display device according to PTL 1 can be improved upon.

In view of this, the present disclosure is capable of improving upon the above related art.

A head-up display according to one aspect of the present disclosure is a head-up display that forms a virtual image by projecting display light onto a display medium. The head-up display includes: an enclosure to which a reflective mirror and a display element are attached. The display element displays an image to emit the display light forming a projected image on the display medium, the reflective mirror reflects the display light toward the display medium, the enclosure is formed as a resin injection-molded component, and when a direction along a parting line plane formed by a cavity and a core of a mold for forming the enclosure is defined as an X-axis direction and a direction along a display surface of the display element that corresponds to a left-right direction of the virtual image is defined as the X-axis direction, the display element is attached to the enclosure with the parting line plane being substantially parallel to the X-axis direction.

The head-up display according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view illustrating a head-up display according to an embodiment provided in a vehicle.

FIG. 2 is a cross-sectional view of a windshield and the head-up display.

FIG. 3 is a plan view illustrating an enclosure of the head-up display and an image generation device according to the embodiment that are provided in the vehicle, as seen from above.

FIG. 4A is a cross-sectional view of the enclosure and the image generation device, taken along line B-B in FIG. 3.

FIG. 4B is a cross-sectional view of an enclosure and an image generation device according to a conventional technique.

FIG. 5A is a cross-sectional view of the image generation device with the enclosure omitted, taken along line A-A in FIG. 3.

FIG. 5B is a diagram illustrating a relationship between a light-emitting module and an illumination lens.

FIG. 6A is a diagram illustrating directions of a display surface of a display element.

FIG. 6B is a diagram illustrating display light emitted from the image generation device in the head-up display.

FIG. 7 is a diagram illustrating images to be displayed on the display surface.

FIG. 8 is a diagram illustrating relationships between the reflective mirror and the image generation device in the head-up display.

FIG. 9 is a diagram illustrating an image generation device including a light guide plate.

FIG. 10 is a diagram illustrating symmetry between a plurality of lens and a plurality of light sources that are formed on the light guide plate.

FIG. 11 is a diagram illustrating respective relationships between display light projected onto the windshield and a virtual image when the head-up display according to the present embodiment is provided on the left side and the right side of the vehicle.

### DESCRIPTION OF EMBODIMENT

The following specifically describes one or more embodiments with reference to the drawings.

Note that each of the one or more embodiments described below shows a general or specific example. The numerical values, shapes, structural elements, the arrangement and connection of the structural elements mentioned in the following one or more embodiments are mere examples and not intended to limit the present disclosure. Moreover, among the structural elements in the following one or more embodiments, structural elements not recited in any one of the independent claims are described as optional structural elements.

Moreover, the figures are schematic illustrations and are not necessarily precise illustrations. Accordingly, for example, the figures are not necessarily to scale. Moreover, in the figures, structural elements that are essentially the same share like reference signs, and duplicate description is omitted or simplified.

In the following one or more embodiments, a front-rear direction of a vehicle has the same meaning as the longitudinal direction of the vehicle, and a left-right direction of the vehicle has the same meaning as the lateral direction of the vehicle. The forward direction (front or front side) of the vehicle is the direction in front of the user seated in the driver's seat. The rearward direction (rear or rear side) of the vehicle is a direction opposite to the forward direction of the vehicle. The rightward direction (right or right side) of the vehicle is the rightward direction when the user sits in the driver's seat. The leftward direction (left or left side) of the vehicle is a direction opposite to the rightward direction of the vehicle.

Moreover, in the following one or more embodiments, terms such as a forward direction (front or front side), a rectangular shape, and substantially parallel are used. For example, the term “forward direction (front or front side)” is intended to include not only the exact forward direction, but also includes directions that are substantially front. The term “rectangular shape” means not only an exact rectangle, but also intended to include a substantially rectangular shape. The term “substantially parallel” means not only exactly parallel, but also includes being substantially parallel. In other words, these terms may include an error of about a few percent or several percent. Moreover, the terms “forward direction (front or front side)”, “rectangular shape”, and “substantially parallel” respectively mean an X-axis direction, a rectangular shape, and substantially parallel in a scope in which effects yielded by the present disclosure can be achieved. The same also applies to other expressions indicating directions, shapes, and the term “substantially”.

### Embodiment

### Configuration

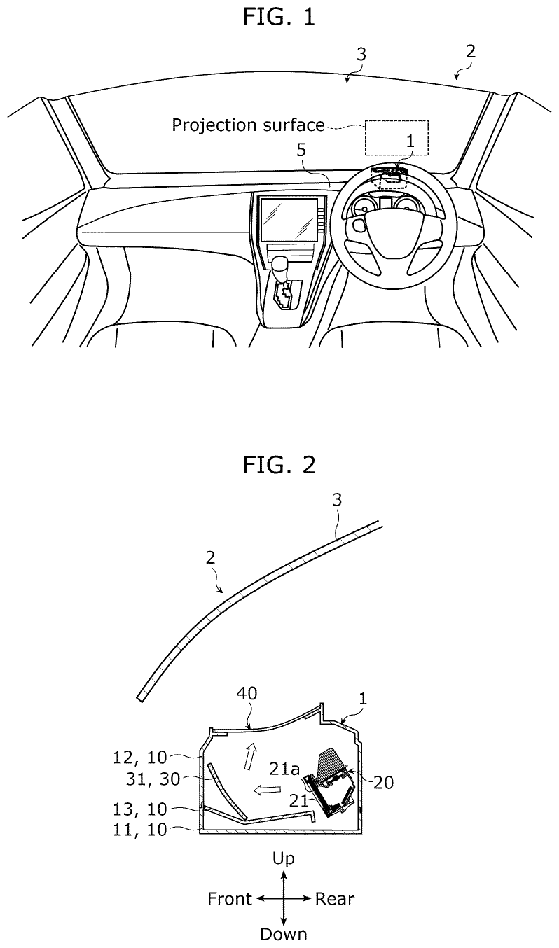

The following specifically describes head-up display 1 according to the present disclosure, with reference to FIG. 1 to FIG. 11.

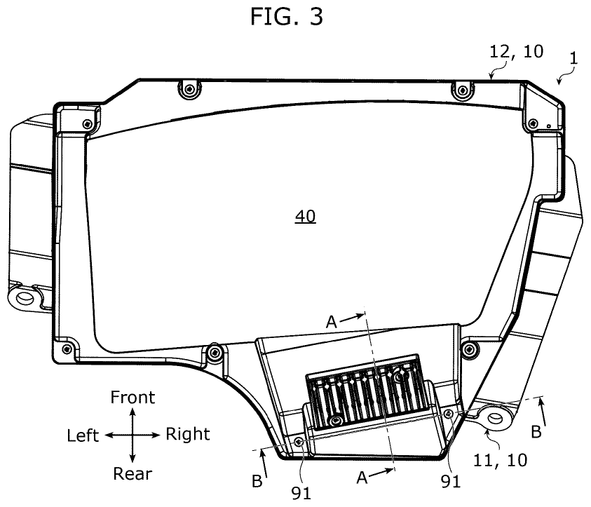

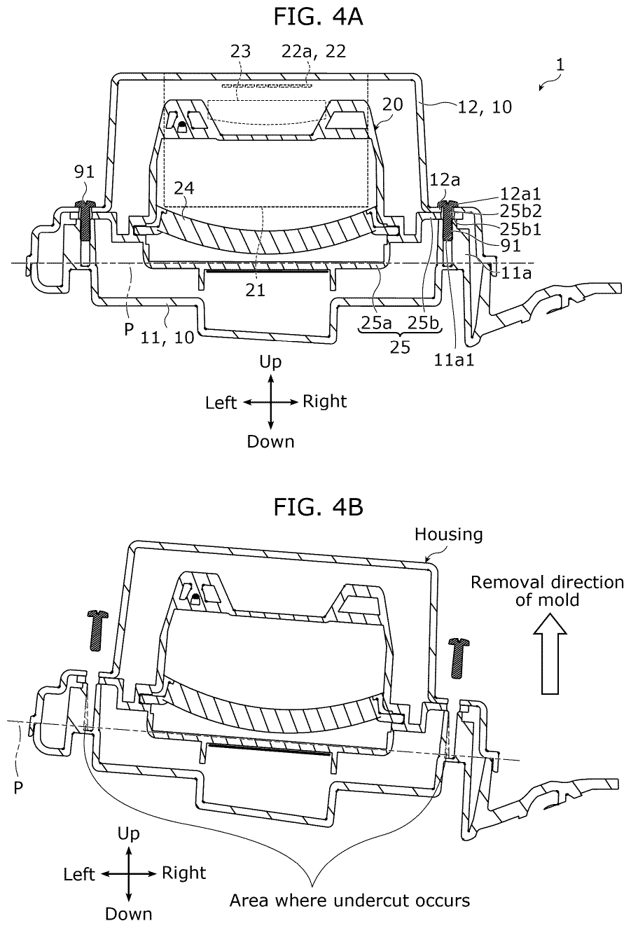

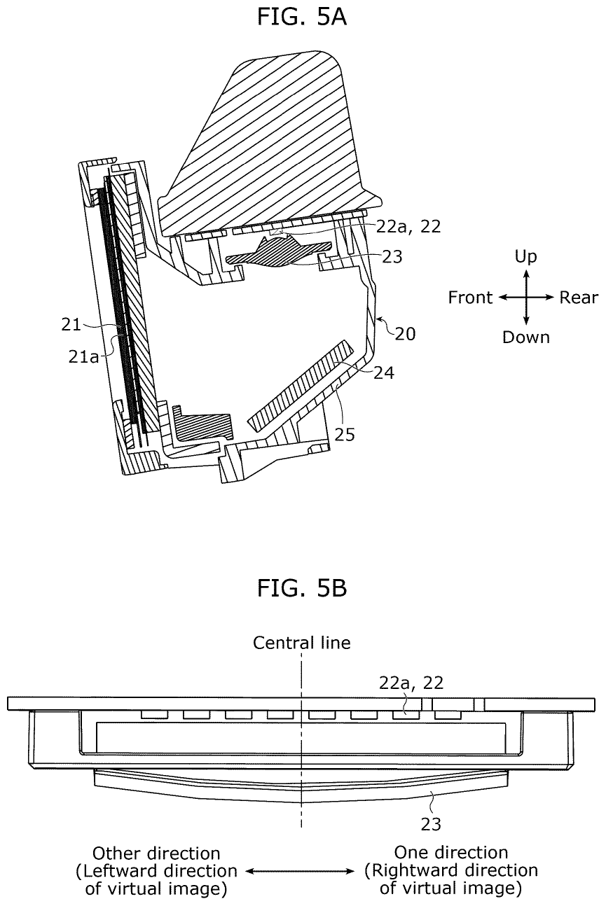

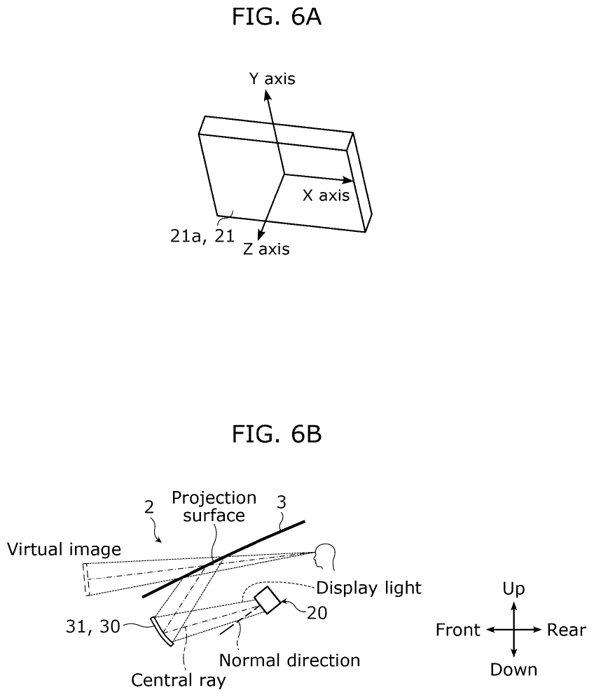

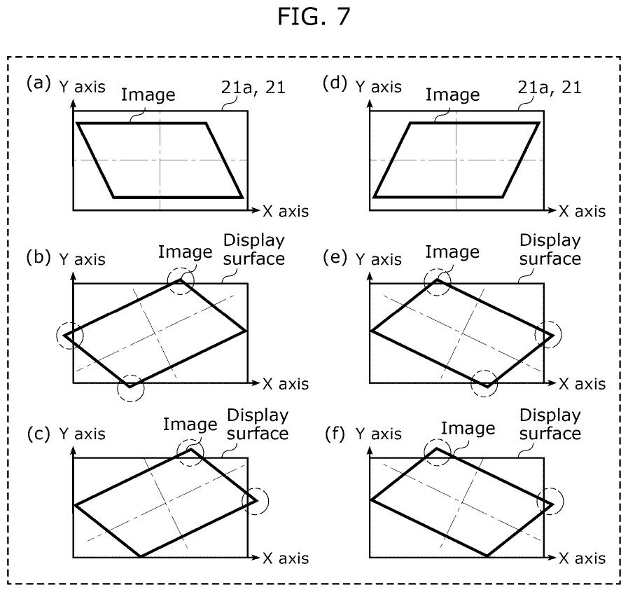

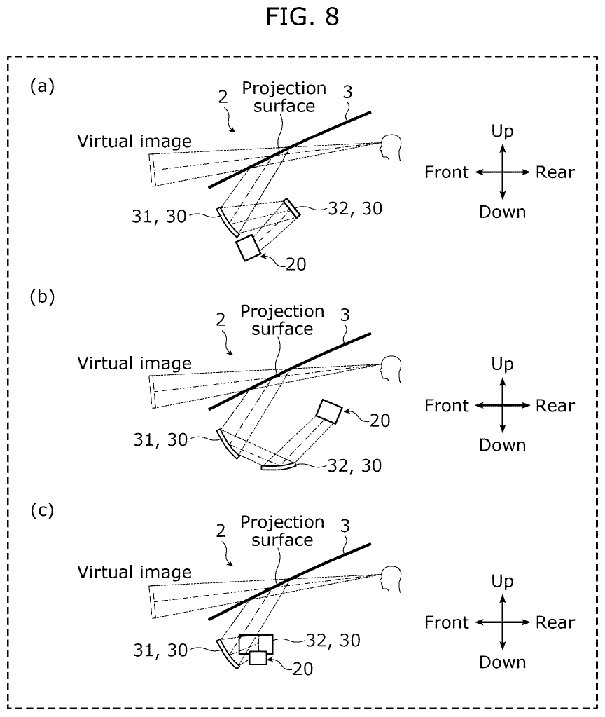

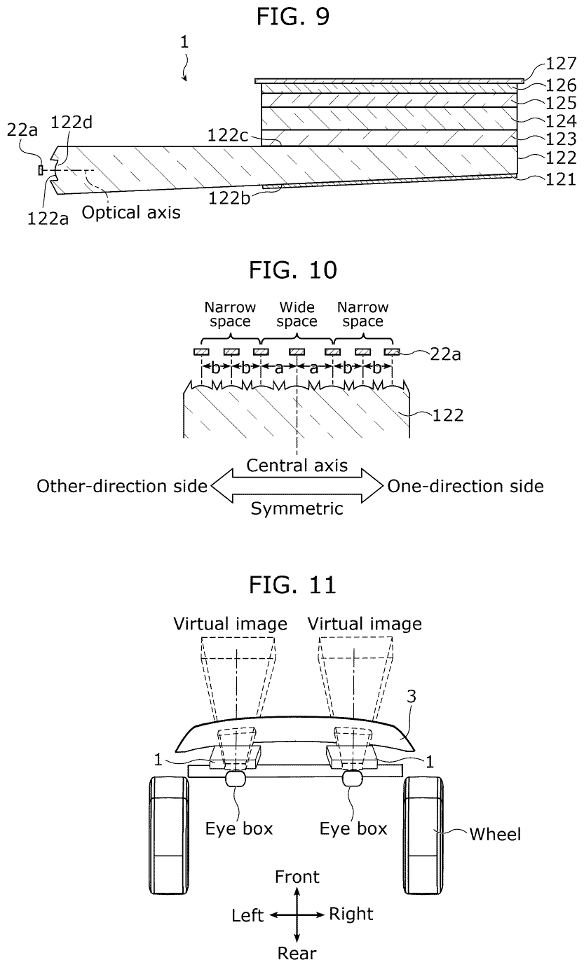

FIG. 1 is a perspective view illustrating head-up display 1 according to an embodiment provided in vehicle 2. FIG. 2 is a cross-sectional view of windshield 3 and head-up display 1. FIG. 3 is a plan view illustrating an enclosure of head-up display 1 according to the embodiment and image generation device 20 that are provided in vehicle 2, as seen from above. FIG. 4A is a cross-sectional view of the enclosure and image generation device 20, taken along line B-B in FIG. 3. FIG. 4B is a cross-sectional view of an enclosure and an image generation device according to a conventional technique. FIG. 5A is a cross-sectional view of image generation device 20 with the enclosure omitted, taken along line A-A in FIG. 3. FIG. 5B is a diagram illustrating a relationship between light-emitting module 22 and illumination lens 23. FIG. 6A is a diagram illustrating directions of display surface 21a of display element 21. FIG. 6B is a diagram illustrating display light emitted from image generation device 20 in head-up display 1. FIG. 7 is a diagram illustrating images to be displayed on display surface 21a. FIG. 8 is a diagram illustrating relationships between reflective mirror 30 and image generation device 20 in head-up display 1. FIG. 9 is a diagram illustrating image generation device 20 including light guide plate 122. FIG. 10 is a diagram illustrating symmetry between a plurality of lens and a plurality of light sources 22a that are formed on light guide plate 122. FIG. 11 is a diagram illustrating respective relationships between display light projected onto windshield 3 and a virtual image when head-up display 1 according to the present embodiment is provided on the left side and the right side of vehicle 2.

First, a schematic configuration of head-up display 1 will be described.

As illustrated in FIG. 1 and FIG. 2, for example, head-up display 1 is provided to dashboard 5 (also called instrument panel) of vehicle 2 that travels on a travel surface. Windshield 3 is disposed above dashboard 5 of vehicle 2. Head-up display 1 is disposed in dashboard 5.

Head-up display 1 is provided in vehicle 2. Head-up display 1 can transmit display light, project an image onto a display medium that is reflective, and form a virtual image on the opposite side of an observer with respect to the display medium.

For example, head-up display 1 can display a virtual image shown by display light to an observer such as a user by reflecting the display light, showing an image emitted from image generation device 20, off windshield 3 or a display medium such as a light-transmissive combiner. In other words, head-up display 1 can display an image shown by display light emitted by image generation device 20 on windshield 3 by projecting the display light onto windshield 3. With this, the image projected onto windshield 3 of vehicle 2 is viewed by the observer. In FIG. 1 and thereafter in the present embodiment, cases where head-up display 1 projects display light onto windshield 3 are described.

Here, display light is light showing a projection image including one or more numerical values, characters, graphics, etc., and is displayed as a virtual image forward of windshield 3. The projection image is a still image or a moving image, and is an image of one or more numerical values, characters, graphics, etc.

As illustrated in FIG. 2 and FIG. 3, head-up display 1 includes housing 10, one or more reflective mirrors 30, and image generation device 20.

Housing 10 is an accommodating body that accommodates image generation device 20 and one or more reflective mirrors 30. Housing 10 is formed from a resin material, etc. and forms an outer shell of head-up display 1. Housing 10 is fixed to vehicle 2 with attached to dashboard 5. In the upper portion of housing 10, a housing opening for passing and transmitting display light to the outside is formed. Dust cover 40 is disposed on the housing opening. Housing 10 is an example of the enclosure.

Housing 10 includes inner cover 13, first housing 11, and second housing 12.

Inner cover 13 is contained in first housing 11 and second housing 12, and is disposed to divide the space inside first housing 11 and second housing 12 into an upper space and a lower space. Inner cover 13 can inhibit light such as the display light emitted by image generation device 20 and outside light that has entered from the outside of head-up display 1 from becoming stray light.

First housing 11 and second housing 12 form an accommodating body that accommodate inner cover 13, image generation device 20, and one or more reflective mirrors 30. First housing 11 and second housing 12 form the outside shell of head-up display 1.

First housing 11 is a bottomed container and fixed to vehicle 2 with being attached to dashboard 5. In the upper portion of first housing 11, a first connecting opening for connecting to second housing 12 is formed. The first connecting opening is provided to correspond to the shape and the position of a second connecting opening formed in the lower portion of second housing 12.

Second housing 12 is a rectangular frame-shaped body, and includes a rectangular housing opening formed in the middle portion to allow display light to pass through to the outside. Dust cover 40 is disposed at the housing opening. Dust cover 40 covers the housing opening.

The first connecting opening of first housing 11 and the second connecting opening of second housing 12 are brought together, and second housing 12 is attached to first housing 11. Specifically, the engaging portion of second housing 12 engages with engaged portion first housing 11. With this, first housing 11 and second housing 12 are connected to form an accommodating body.

As illustrated in FIG. 4A, each of first housing 11 and second housing 12 is formed as a resin injection-molded component. For example, the housing mold of an injection molding machine is designed and prepared to include a cavity, which is a movable side, and a core, which is a fixed side. Bringing the cavity and the core together forms the molding space for molding housing 10. Injecting a resin into the molding space via a gate of the cavity to pour the resin into the space for molding. When the resin solidifies, first housing 11 and second housing 12 are obtained, which are resin molded components with the shape of the molding space transferred. Here, when the resin injection-molded component is formed, a parting line is formed at the interface of the cavity and the core.

The parting line is substantially parallel to the front-rear direction and the left-right direction of vehicle 2. Parting line plane P parallel to the parting line is formed on each of first housing 11 and second housing 12. Parting line plane P is substantially parallel to the plane defined by the front-rear direction and the left-right direction of vehicle 2. In the present embodiment, parting line plane P in head-up display 1 provided in vehicle 2 becomes substantially parallel to the horizontal plane when vehicle 2 is placed on the horizontal surface.

Here, the term “front-rear direction of vehicle 2” means being substantially parallel to the front-rear direction of vehicle 2. The term “left-right direction of vehicle 2” means being substantially parallel to the left-right direction of vehicle 2.

As illustrated in FIG. 4B, in the conventional technique, parting line plane P is inclined relative to the left-right direction of the vehicle, and is not parallel to the left-right direction. Therefore, in the conventional technique, parting line plane P is not parallel to the plane defined by the front-rear direction and the left-right direction of the vehicle. Therefore, when the removal direction of the housing mold in the injection molding machine is parallel to the upward direction, one or more undercuts are produced when the housing is molded in the conventional technique.

However, in housing 10 according to the present embodiment, parting line plane P and the left-right direction are substantially parallel, and thus no undercut is produced. With this, the present embodiment can inhibit an increase in manufacturing cost compared with the housing in FIG. 4B.

One or more reflective mirrors 30 of such head-up display 1 include first reflective mirror 31 as illustrated in FIG. 2.

First reflective mirror 31 and image generation device 20 are disposed in housing 10 to face each other at a predetermined distance. Specifically, first reflective mirror 31 is disposed on the forward side of vehicle 2 in housing 10 to be opposite to display surface 21a of image generation device 20 disposed on the rear side of vehicle 2 in housing 10. Therefore, first reflective mirror 31 can reflect the display light emitted by image generation device 20 toward windshield 3 via dust cover 40.

First reflective mirror 31 is a concave mirror with a freeform surface. Moreover, in the present embodiment, first reflective mirror 31 is a rectangular mirror elongated in the left-right direction of vehicle 2. Note that the shape of first reflective mirror 31 may be any shape, and may be polygonal or circular.

Moreover, first reflective mirror 31 may be pivotable about an axis extending in the left-right direction of vehicle 2. In this case, the position of the virtual image to be projected onto windshield 3 may be adjusted. First reflective mirror 31 may be pivoted by manually or electrically by a drive mechanism.

Image generation device 20 can generate an image, and output display light showing the generated image so that the generated image can be projected onto windshield 3. Specifically, image generation device 20 emits display light from display element 21. The display light emitted from display element 21 of image generation device 20 is reflected off first reflective mirror 31 and passes through dust cover 40. Then, the display light is emitted from head-up display 1 to be projected onto windshield 3. In other words, image generation device 20 can project a predetermined image as a virtual image on windshield 3 by emitting display light. When display light is reflected off windshield 3, a user can recognize a virtual image. Image generation device 20 is, for example, a liquid crystal display device including a liquid crystal display, etc.

As illustrated in FIG. 5A, image generation device 20 includes display element 21, light-emitting module 22, illumination lens 23, optical mirror 24, and case 25.

Display element 21 is liquid crystal display element 21, such as a liquid crystal panel. In display element 21, display surface 21a emits light when illuminated by light-emitting module 22 from the rear surface side. In display element 21, display light showing an image including, for example, one or more numerical values, characters, and graphics is emitted from display surface 21a, in response to a control instruction from an electronic control unit (ECU) provided in vehicle 2. Specifically, display element 21 can display an image by being driven by alternating current power obtained from a power source in vehicle 2. With this, display element 21 can emit, from display surface 21a, display light forming a projected image on windshield 3.

Light-emitting module 22 includes a plurality of light sources 22a arranged in a predetermined direction and a substrate on which the plurality of light sources 22a are mounted. The plurality of light sources 22a are held such that light sources 22a emit light toward optical mirror 24 via illumination lens 23. Each of the plurality of light sources 22a includes, for example, a light-emitting diode. For example, each of the plurality of light sources 22a is driven by direct current power obtained from the power source in vehicle 2.

Illumination lens 23 is disposed in the direction in which light is emitted by each light source 22a and in the path of light between light sources 22a and optical mirror 24. Illumination lens 23 can transmit light emitted from light sources 22a toward optical mirror 24.

Illumination lens 23 correspond to the plurality of light sources 22a. In other words, illumination lens 23 has a shape elongated in the arrangement direction of the plurality of light sources 22a. Illumination lens 23 also extends in a predetermined direction as with the arrangement direction of the plurality of light sources 22a. The predetermined direction may be substantially parallel to the left-right direction of vehicle 2, or may not be parallel to the left-right direction of vehicle 2, for example.

Illumination lens 23 that extends in the predetermined direction corresponding to the left-right direction of display element 21 has a shape in which a one-direction side and the other-direction side in the predetermined direction are symmetrical. Such a relationship between illumination lens 23 and the plurality of light sources 22a enables illumination lens 23 to collect light emitted by each of the plurality of light sources 22a and transmit light with reduced luminance non-uniformity toward optical mirror 24.

Optical mirror 24 is disposed in case 25 to face light source 22a and illumination lens 23 at a predetermined distance. Specifically, optical mirror 24 is disposed in the emission direction of light of light sources 22a that is emitted from illumination lens 23, and in the optical path between (i) light sources 22a and illumination lens 23 and (ii) display element 21. In other words, optical mirror 24 is disposed at a position opposite display element 21 and illumination lens 23. Therefore, optical mirror 24 can reflect light emitted by light sources 22a and collected by illumination lens 23 toward display element 21.

Optical mirror 24 is a plane mirror or a concave mirror including a freeform surface. In the present embodiment, optical mirror 24 is a rectangular mirror elongated in the left-right direction of vehicle 2. Note that the shape of optical mirror 24 may be any shape, and may be polygonal or circular.

Accordingly, the light emitted by light sources 22a is collected by illumination lens 23 and incident on optical mirror 24. Optical mirror 24 reflects the incident light toward display element 21. With this, the light emitted by light sources 22a enters display element 21. Since the light of light sources 22a passes through display element 21, display element 21 can emit display light showing the displayed image.

As illustrated in FIG. 4A, case 25 is also formed as a resin injection-molded component using a case mold of an injection molding machine, as with first housing 11 and second housing 12.

Optical mirror 24 and display element 21 are attached to case 25. Case 25 can contain display element 21, light-emitting module 22, illumination lens 23, and optical mirror 24. Case 25 is connected to first housing 11 and second housing 12 by one or more fastening components 91.

Specifically, case 25 includes accommodating portion 25a that accommodates display element 21, light-emitting module 22, illumination lens 23, and optical mirror 24. On the outer periphery of accommodating portion 25a, connection piece 25b that is flange-shaped is formed. Connection piece 25b is fastened to first attachment portion 11a and connected to first housing 11 and second attachment portion 12a of second housing 12 by one or more fastening components 91. Connection piece 25b includes through hole 25b2 that is formed to correspond to through hole 12a1 of second attachment portion 12a and fastening hole 11a1 of first attachment portion 11a.

Connection piece 25b has attachment surface 25b1 for attaching to housing 10. Attachment surface 25b1 is substantially parallel to parting line plane P. Attachment surface 25b1 is a lower surface of connection piece 25b, and substantially parallel to the left-right direction of vehicle 2. Attachment surface 25b1 is in close contact with the upper surface of first attachment portion 11a of first housing 11.

When case 25 is attached to first housing 11 and second housing 12, the alignment direction of through hole 12a1 of second attachment portion 12a of second housing 12, through hole 25b2 of connection piece 25b, and fastening hole 11a1 of first attachment portion 11a of first housing 11 is substantially perpendicular to parting line plane P and substantially parallel to the up-down direction. The direction in which fastening portion 91 is inserted is substantially parallel to the up-down direction.

Here, as illustrated in FIG. 6A, display surface 21a of display element 21 defines an X-axis direction, a Y-axis direction, and a Z-axis direction. The direction along display surface 21a of display element 21 that corresponds to the left-right direction of a virtual image is defined as the X-axis direction. The direction along display surface 21a of display element 21 that corresponds to the up-down direction of the virtual image is defined as the Y-axis direction. The direction perpendicular to display surface 21a is defined as the Z-axis direction. Specifically, the leftward direction (left) of the virtual image may be defined as the positive X-axis direction, the rightward direction (right) of the virtual image may be defined as the negative X-axis direction, the upward direction (up) of the virtual image may be defined as the positive Y-axis direction, the downward direction (down) of the virtual image may be defined as the negative Y-axis direction, the forward direction (front) of the virtual image may be defined as the positive Z-axis direction, and the rearward direction (rear) of the virtual image may be defined as the negative Z-axis direction.

In this case, display element 21 can be attached to housing 10 via case 25 such that parting line plane P and the X-axis direction are substantially parallel to each other.

In this case, as illustrated in FIG. 6B, when the light ray traveling toward the center of the virtual image from display element 21 is defined as the central ray, the direction of the central ray emitted from display element 21 differs from the normal direction of display surface 21a of display element 21.

When the direction perpendicular to the X-axis direction and along display surface 21a that corresponds to the up-down direction of the virtual image is defined as the Y-axis direction, a component in the X-axis direction of the display light emitted from display element 21 is less than or equal to 1/20 of one or more components of the display light emitted from display element 21 in one or more directions other than the X-axis direction.

When such head-up display 1 is provided in vehicle 2, image generation device 20 can be made common to both the left and right sides. For example, (a) in FIG. 7 illustrates an image to be displayed on display surface 21a when head-up display 1 equipped with image generation device 20 including display element 21 is disposed on the left side of vehicle 2 (for left-hand drive vehicle). In FIG. 7, (d) illustrates an image to be displayed on display surface 21a when head-up display 1 equipped with image generation device 20 including display element 21 is disposed on the right side of vehicle 2 (for right-hand drive vehicle). Each of (b) and (c) in FIG. 7 illustrates an image to be displayed on a display surface when a head-up display including an image generation device that is made common to both the left and right sides according to the conventional technique is disposed on the left side of a vehicle (for left-hand drive vehicle). Each of (e) and (f) in FIG. 7 illustrates an image to be displayed on the display surface when the head-up display including the image generation device that is made common to both the left and right sides according to the conventional technique is disposed on the right side of the vehicle (for right-hand drive vehicle).

In each of (a) and (d) in FIG. 7 according to the present embodiment, the image appears within display surface 21a. In such cases, the virtual image is projected onto windshield 3 without being cut off.

However, when the image generation device according to the conventional technique is used for a head-up display to make the image generation device common to both the left and right sides, the parting line plane and the direction along the display surface of the display element is not parallel to the X-axis direction. Therefore, in each of (b), (c), (e), and (f) in FIG. 7, the image is cut off as shown with two-dot chain line circles, and the virtual image would be projected onto the windshield with partially being cut off. In these cases, the user may not correctly recognize necessary information or may feel that the virtual image is unnatural. Therefore, the image generation device according to the conventional technique cannot be made common to both the left and right sides.

Although the foregoing has described head-up display 1 equipped with first reflective mirror 31, head-up display 1 according to the present embodiment should not be limited to this example.

Specifically, as illustrated in (a) in FIG. 8, head-up display 1 may further include second reflective mirror 32. In other words, one or more reflective mirrors 30 may include second reflective mirror 32 in addition to first reflective mirror 31. In other words, the enclosure may further include second reflective mirror 32. Second reflective mirror 32 may be a plane mirror. Moreover, the light-reflecting surface of second reflective mirror 32 may be a curved surface including a freeform surface.

In this case, image generation device 20 is disposed below first reflective mirror 31 and second reflective mirror 32, and on the front side of vehicle 2 relative to second reflective mirror 32. First reflective mirror 31 and second reflective mirror 32 are disposed in housing 10 to face each other at a predetermined distance. First reflective mirror 31 is disposed on the front side of vehicle 2 in housing 10 to be opposite display surface 21a of image generation device 20 disposed on the front side of vehicle 2 and second reflective mirror 32 in housing 10. Second reflective mirror 32 is disposed on the rear side of vehicle 2 relative to first reflective mirror 31, and aligned with first reflective mirror 31 in the front-rear direction of vehicle 2. With this, second reflective mirror 32 reflects display light emitted by image generation device 20 toward first reflective mirror 31. Moreover, first reflective mirror 31 reflects the display light reflected by second reflective mirror 32 toward dust cover 40 via the housing opening.

Moreover, although the foregoing has described that image generation device 20 including display element 21 in FIG. 5A is disposed below first reflective mirror 31 and second reflective mirror 32, the present embodiment should not be limited to this configuration. As illustrated in (b) in FIG. 8, image generation device 20 including display element 21 in FIG. 5A may be disposed above first reflective mirror 31 and second reflective mirror 32.

Display element 21 may be disposed on the left side or the right side of second reflective mirror 32. In (c) in FIG. 8, an example in which display element 21 is disposed on the left side of second reflective mirror 32 is illustrated.

Head-up display 1 including light guide plate 122 as illustrated in FIG. 9 and FIG. 10 may also be used as head-up display 1 according to the present embodiment.

Such head-up display 1 includes a plurality of light sources 22a, light guide plate 122, mirror sheet 121, prism plate 123, Fresnel lens 124, heat-dissipating glass 125, liquid crystal panel 126, and cover member 127.

Light guide plate 122 includes incidence surface 122a where light emitted by light source 22a is incident, reflection surface 122b that reflects the light entering from incidence surface 122a, and light-emission plate 122c that is opposite reflection surface 122b. Light guide plate 122 extends along the optical axis of the light emitted by light source 22a. This light guide plate 122 has a thickness that gradually decreases in the direction along the optical axis away from incidence surface 122a. Therefore, reflection surface 122b is inclined relative to incidence surface 122a.

As illustrated in FIG. 10, a plurality of lens structures 122d are formed on incidence surface 122a of light guide plate 122. The plurality of lens structures 122d are in one-to-one correspondence to the plurality of light sources 22a. The plurality of lens structures 122d and the plurality of light sources 22a are aligned along a predetermined direction corresponding to the left-right direction of a virtual image. When the central axis of light guide plate 122 is defined, the plurality of lens structures 122d and the plurality of light sources 22a are arranged such that the one-direction side and the other-direction side are symmetrical relative to the central axis. The central axis is substantially parallel to the optical axes of light sources 22a. In the vicinity of the central axis, the space between two adjacent light sources 22a is set to space a, and on the end portion side of incidence surface 122a that is away from the central axis, the space between two adjacent light sources 22a is set to space b, which is narrower than space a.

Note that in FIG. 10, an example of space a being narrower than space b is illustrated, but this should not be construed as limiting. For example, space a may be narrower than space b. In other words, space b may be narrower or wider than space a in the direction away from the central axis.

Mirror sheet 121 is overlaid on reflection surface 122b. Mirror sheet 121 can reflect light toward light emission surface 122c.

Prism plate 123 is disposed on the side where light emission surface 122c is located, which is opposite to the side on which mirror sheet 121 is located.

Fresnel lens 124 is disposed on the side where prism plate 123 is located, which is opposite to the side of prism plate 123 closer to light guide plate 122.

Heat-dissipating glass 125 is disposed on the side where Fresnel lens 124 is located, which is opposite to the side of Fresnel lens 124 closer to prism plate 123.

Liquid crystal panel 126 is disposed on the side where heat-dissipating glass 125 is located, which is opposite to the side of heat-dissipating glass 125 closer to Fresnel lens 124.

Cover member 127 is disposed to overlap liquid crystal panel 126, which is located opposite to the side of liquid crystal panel 126 closer to heat-dissipating glass 125.

Accordingly, in head-up display 1 including light guide plate 122, the following structural elements are stacked in stated order: mirror sheet 121, light guide plate 122, prism plate 123, Fresnel lens 124, heat-dissipating glass 125, liquid crystal panel 126, and cover member 127.

When such head-up display 1 according to the present embodiment is provided on each of the left side and the right side of vehicle 2, as illustrated in FIG. 11, display light is symmetrically projected onto windshield 3. Therefore, head-up display 1 according to the present embodiment can project the virtual image onto windshield 3 without being cut off.

### Advantageous Effects

Next, advantageous effects of head-up display 1 according to the present embodiment will be described.

For example, there has been a demand that an image generation device, such as a picture generation unit (PGU) of a head-up display provided in a vehicle, can be made common to both the left and right sides to support both left-hand drive vehicles and right-hand drive vehicles. In this case, the configuration for fastening the enclosure of the image generation device to the main housing of the head-up display is required to be bilaterally symmetrical. In this case, the image generation device is inclined relative to the parting line plane between the cavity and the core of the mold used for forming a main housing, and thus the cavity and the core of the mold cannot be configured as top and bottom halves. In this case, a slidable mold split should be used, or a mold for left-hand drive vehicles and a mold for right-hand drive vehicles should be made. Therefore, an increase in costs of the molds increase the manufacturing cost of the head-up displays.

In view of this, as described above, head-up display 1 according to Technique 1 of the present embodiment is head-up display 1 that forms a virtual image by projecting display light onto a display medium (e.g., windshield 3), and includes: an enclosure (housing 10) to which reflective mirror 30 and display element 21 are attached. Display element 21 displays an image to emit the display light forming a projected image on the display medium, reflective mirror 30 reflects the display light toward the display medium, the enclosure is formed as a resin injection-molded component, and when a direction along parting line plane P formed by a cavity and a core of a mold for forming the enclosure is defined as an X-axis direction and a direction along display surface 21a of display element 21 that corresponds to a left-right direction of the virtual image is defined as the X-axis direction, display element 21 is attached to the enclosure with parting line plane P being substantially parallel to the X-axis direction.

With this, since parting line plane P becomes substantially parallel to the X-axis direction, image generation device 20 can be made common to both the left and right sides.

In this case, when the enclosure is resin-injection molded, the cavity of the enclosure mold can be removed from the core in the direction perpendicular to the parting line produced in the resin-injection molding procedure of the enclosure. In other words, one or more undercuts such as those in FIG. 4B would not be easily produced, and the cavity is not required to be slidable mold split, and thus an increase in the manufacturing cost of the enclosure mold can be inhibited.

Therefore, with this head-up display 1, image generation device 20 can be made common to both the left and right sides. Accordingly, an increase in the manufacturing cost of head-up display 1 can be inhibited.

Moreover, in head-up display 1 according to Technique 2 of the present embodiment, display element 21 is contained in case 25, case 25 is attached to the enclosure, and attachment surface 25b1 of case 25 for attaching to the enclosure is substantially parallel to parting line plane P.

With this, display element 21 can be disposed such that parting line plane P is substantially parallel to the X-axis direction. Therefore, image generation device 20 can be made common to both the left and right sides, and an increase in the manufacturing cost of head-up display 1 can be inhibited.

Moreover, in head-up display 1 according to Technique 3 of the present embodiment, when head-up display 1 is provided in vehicle 2, parting line plane P is substantially parallel to ground.

With this, display element 21 can be disposed such that the X-axis direction of display element 21 is substantially parallel to the ground. Therefore, image generation device 20 can be made common to both the left and right sides, and an increase in the manufacturing cost of head-up display 1 can be inhibited.

Moreover, in head-up display 1 according to Technique 4 of the present embodiment, when a light ray traveling toward a center of the virtual image from display element 21 is defined as a central ray, a direction of the central ray emitted from display element 21 differs from a normal direction of display surface 21a of display element 21.

With this, when the direction of the central ray of the display light differs from the normal direction of display surface 21a, the display light can be reflected off the projection surface of windshield 3 at an appropriate angle through the reflective mirror. In other words, the display light can be appropriately reflected by the reflective mirror, a decrease in the use efficiency of light can be inhibited. With this, it is expected that the user can clearly view the virtual image projected onto the projection surface of windshield 3, and the visibility and clarity can be increased.

Moreover, since the display light would not be concentrated on a specific region and tends to be equally distributed across the projection surface of windshield 3, luminance non-uniformity of the virtual image projected onto windshield 3 can be inhibited. With this, the displayed virtual image appears more uniform and brighter.

Moreover, in head-up display 1 according to Technique 5 of the present embodiment, when a direction perpendicular to the X-axis direction and along display surface 21a that corresponds to an up-down direction of the virtual image is defined as a Y-axis direction, and a direction perpendicular to display surface 21a is defined as a Z-axis direction, a component in the X-axis direction of the display light emitted from display element 21 is less than or equal to 1/20 of one or more components of the display light emitted from display element 21 in one or more directions other than the X-axis direction.

With this, the one or more components in one or more directions other than the X-axis direction can be minimized as much as possible, and thus the luminance non-uniformity of in the left-right direction of the virtual image projected onto windshield 3 is less likely to be produced. Therefore, this head-up display 1 can display a visually stable virtual image to a user.

Moreover, in head-up display 1 according to Technique 6, case 25 includes illumination lens 23 that extends in a predetermined direction corresponding to a left-right direction of display element 21, and illumination lens 23 is symmetric between a one-direction side and an other-direction side in the predetermined direction.

With this, the symmetry of the virtual image can be matched with the symmetry of illumination lens 23 in the predetermined direction. In this case, the display light can be projected onto the projection surface of windshield 3 to have bilaterally symmetric luminance. Since illuminance non-uniformity of the virtual image projected onto windshield 3 can be inhibited in the left-right direction of the virtual image, a user can clearly view the virtual image, and an increase in visibility and clarity can be expected.

Moreover, in head-up display 1 according to Technique 7 of the present embodiment, the reflective mirror is disposed at a position opposite display element 21.

With this, by using one reflective mirror and one display element 21, it is possible to reduce the complexity of the structure and the system of head-up display 1, and avoid a complex optical design. Accordingly, downsizing of the overall structure of head-up display 1 can be expected, as well as reducing the manufacturing cost and simplifying the maintenance.

Moreover, in head-up display 1 according to Technique 8 of the present embodiment, the enclosure further includes a folding mirror (second reflective mirror 32), and the folding mirror (second reflective mirror 32) reflects the display light emitted by display element 21 toward the reflective mirror.

With this, providing first reflective mirror 31 and second reflective mirror 32 in head-up display 1 can adjust the display light to be projected toward the eye box at an optimal angle. In other words, use of first reflective mirror 31 and second reflective mirror 32 enables fine adjustment of the reflection path of the display light, and thus it is expected to secure an optimal visibility for a user. Especially, since the projection position in the field of view can be appropriately adjusted, the user can view the virtual image comfortably even during driving.

Moreover, use of first reflective mirror 31 and second reflective mirror 32 permits flexibility in placement of display element 21 and reflective mirror 30.

Moreover, in head-up display 1 according to Technique 9 of the present embodiment, display element 21 is disposed above or below the folding mirror (second reflective mirror 32).

With this, disposing display element 21 above or below second reflective mirror 32 makes it possible to efficiently incorporate head-up display 1 in a limited space in a vehicle. Especially since second reflective mirror 32 can be disposed according to the design of the instrument panel or dashboard, the display system can be housed compactly and the likelihood of interference with other components in vehicle 2 can be reduced.

Moreover, in head-up display 1 according to Technique 10 of the present embodiment, display element 21 is disposed on a left side or a right side of the folding mirror (second reflective mirror 32).

With this, disposing display element 21 on the left side or the right side of second reflective mirror 32 makes it possible to efficiently incorporate head-up display 1 in a limited space in a vehicle. Especially, since second reflective mirror 32 can be disposed according to the design of the instrument panel or dashboard, the display system can be housed compactly and reduce the likelihood of interference with other components in vehicle 2 can be reduced.

Moreover, in head-up display 1 according to Technique 11 of the present embodiment, the folding mirror (second reflective mirror 32) is a plane mirror.

With this, since the reflection angle is equal to the incident angle, the optical path can be accurately predicted. Therefore, this facilitates the optical design.

Moreover, since the plane mirror is flat-shaped, distortion of reflected light is unlikely to occur. With this, it is expected that the user can clearly view the virtual image, and the visibility and clarity can be increased.

Moreover, in head-up display 1 according to Technique 12 of the present embodiment, a light-reflecting surface of the folding mirror (second reflective mirror 32) is a curved surface including a freeform surface.

With this, since the light-reflecting surface is freeform surface, the optical path of the reflected display light can be controlled more flexibly. Moreover, by adjusting the curvature of the light-reflecting surface, the display light can be guided to a specific angle and a specific direction. Therefore, it is expected that the virtual image can be displayed at a more optimal position, and the visibility can be improved.

### Other Variations

The foregoing has described the head-up display according to the present disclosure based on the one or more embodiments described above, yet the present disclosure should not be limited to the above-described one or more embodiments. The present disclosure also encompasses embodiments resulting from applying, to the above one or more embodiments, various modifications that may be conceived by those skilled in the art within a range that does not depart from the scope of the present disclosure.

Note that the present disclosure also encompasses embodiments resulting from applying, to the above one or more embodiments, various modifications that may be conceived by those skilled in the art and embodiments resulting from combining structural elements and functions in different embodiments in any manner, within a range that does not depart from the spirit of the present disclosure.

While one or more exemplary embodiments have been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims are incorporated herein by reference in their entirety: Japanese Patent Application No. 2025-058078 filed on Mar. 31, 2025.

### Industrial Applicability

The present disclosure is applicable to a head-up display provided in a vehicle.

1. A head-up display that forms a virtual image by projecting display light onto a display medium, the head-up display comprising:
an enclosure to which a reflective mirror and a display element are attached, wherein
the display element displays an image to emit the display light forming a projected image on the display medium,
the reflective mirror reflects the display light toward the display medium,
the enclosure is formed as a resin injection-molded component, and
when a direction along a parting line plane formed by a cavity and a core of a mold for forming the enclosure is defined as an X-axis direction and a direction along a display surface of the display element that corresponds to a left-right direction of the virtual image is defined as the X-axis direction, the display element is attached to the enclosure with the parting line plane being substantially parallel to the X-axis direction.

2. The head-up display according to claim 1, wherein
the display element is contained in a case,
the case is attached to the enclosure, and
an attachment surface of the case for attaching to the enclosure is substantially parallel to the parting line plane.

3. The head-up display according to claim 1, wherein
when the head-up display is provided in a vehicle, the parting line plane is substantially parallel to ground.

4. The head-up display according to claim 1, wherein
when a light ray traveling toward a center of the virtual image from the display element is defined as a central ray, a direction of the central ray emitted from the display element differs from a normal direction of the display surface of the display element.

5. The head-up display according to claim 1, wherein
when a direction perpendicular to the X-axis direction and along the display surface that corresponds to an up-down direction of the virtual image is defined as a Y-axis direction, and a direction perpendicular to the display surface is defined as a Z-axis direction,
a component in the X-axis direction of the display light emitted from the display element is less than or equal to 1/20 of one or more components of the display light emitted from the display element in one or more directions other than the X-axis direction.

6. The head-up display according to claim 2, wherein
the case includes an illumination lens that extends in a predetermined direction corresponding to a left-right direction of the display element, and
the illumination lens is symmetric between a one-direction side and an other-direction side in the predetermined direction.

7. The head-up display according to claim 1, wherein
the reflective mirror is disposed at a position opposite the display element.

8. The head-up display according to claim 2, wherein
the enclosure further includes a folding mirror, and
the folding mirror reflects the display light emitted by the display element toward the reflective mirror.

9. The head-up display according to claim 8, wherein
the display element is disposed above or below the folding mirror.

10. The head-up display according to claim 8, wherein
the display element is disposed on a left side or a right side of the folding mirror.

11. The head-up display according to claim 8, wherein
the folding mirror is a plane mirror.

12. The head-up display according to claim 8, wherein
a light-reflecting surface of the folding mirror is a curved surface including a freeform surface.
